(19) United States
(12) Patent Application Publication
(10) Pub. No.: US 2011/0110529 A1
(43) Pub. Date: May 12, 2011

(54) WIRELESS AUDIO SYSTEM

(76) Inventor: Kevin R. Semcken, Evergreen, CO (US)

(21) Appl. No.: 12/904,961

(22) Filed: Oct. 14, 2010

Related U.S. Application Data
(60) Provisional application No. 61/252,096, filed on Oct. 15, 2009.

(51) Int. Cl. H04R 1/10

(52) U.S. Cl. 381/74

(57) ABSTRACT

A wireless audio system is provided which includes an audio source and an audio output device such as a headphone set electronically coupled to a wireless lanyard. The lanyard is wirelessly electronically coupled to the audio source, thereby permitting use of the audio system by a remote user without encumbering the user's mobility.

### PRIORITY TO RELATED APPLICATIONS

This is a U.S. Utility Application which claims the benefit of U.S. Provisional Application No. 61/252,096 filed Oct. 15, 2009, the entire contents of which are incorporated herein by reference.

### BACKGROUND OF THE INVENTION

1. Field of the Invention

The present invention generally relates to a wireless audio system. More specifically, the present invention relates to a wireless lanyard that wirelessly electronically couples an audio output device such as a headphone, earphones, an ear bud and the like to an electronic audio source.

2. Background Information

Many electronic devices and audio systems are equipped with a receptacle or jack adapted to receive a plug, a jack or another similar electrical connector for coupling an audio output apparatus such as headphones, earphones, ear buds or the like to the device. Many of these electronic devices such as radios, compact disc players, iPods, telephones and certain televisions are portable and intended for use while the user is mobile. Other electronic devices are stationary but are generally employed while the user is at a distance from the device, e.g., televisions or home stereo equipment. The wire or wires extending from the headphones or ear buds may present a problem to the user of either type of system. With the portable device, the wire or wires often restrict the user's mobility. With the stationary device, the wire or wires restrict the distance from the audio system that the user may utilize headphones or ear buds.

U.S. Pat. Nos. 4,845,751, 5,771,441 and 5,974,304 disclose systems that provide a transmitter connected to an electronic device, thereby enabling the electronic device to communicate with headphones having an antenna. Other prior art systems, such as those disclosed in U.S. Pat. Nos. 4,369,521 and 7,558,607, convert the connector cable extending from the headphones into an antenna. However, these systems do not provide a means to support a connector and wireless receiver such that the user's mobility is not restricted.

U.S. Pat. No. 4,430,757 discloses a support apparatus for a transmitter. However, the support apparatus is not connectable to headphones or ear buds and is incapable of providing a communication link to deliver an audio signal to headphones or ear buds. A belt for attaching a transceiver to the waist of a user is provided in U.S. Pat. No. 6,522,765. However, the belt along with the cable from the headset restrict the user's movement.

In view of the foregoing, it will be apparent to those skilled in the art that a need exists for a wireless audio system having a lanyard that will provide the electronic coupling between an audio system and an audio output device and permit a wide range of mobility for the system user. This invention addresses this need as well as other needs, which will become apparent to those skilled in the art from this disclosure.

### BRIEF DESCRIPTION OF THE DRAWINGS

Referring now to the attached drawings which form a part of this original disclosure:

FIG. 1 is a perspective view of a wireless audio system which includes a wireless lanyard connected to headphones and an adapter;

FIG. 2 is a perspective view of the wireless lanyard of FIG. 1 with sliding cable locks and cable connectors; and

FIG. 3 is a perspective view of another embodiment of the wireless, lanyard having dual headphone plugs.

### DETAILED DESCRIPTION OF THE PREFERRED EMBODIMENTS

Preferred embodiments of the present invention will now be explained with reference to the drawings. It will be apparent to those skilled in the art from this disclosure that the following description of the embodiments of the present invention is provided for illustration only and not for the purpose of limiting the invention as defined by the appended claims and their equivalents.

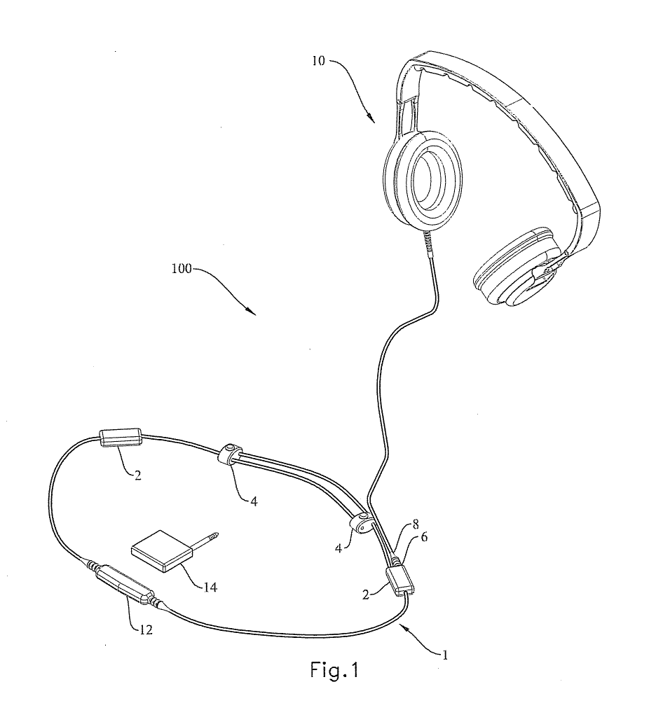

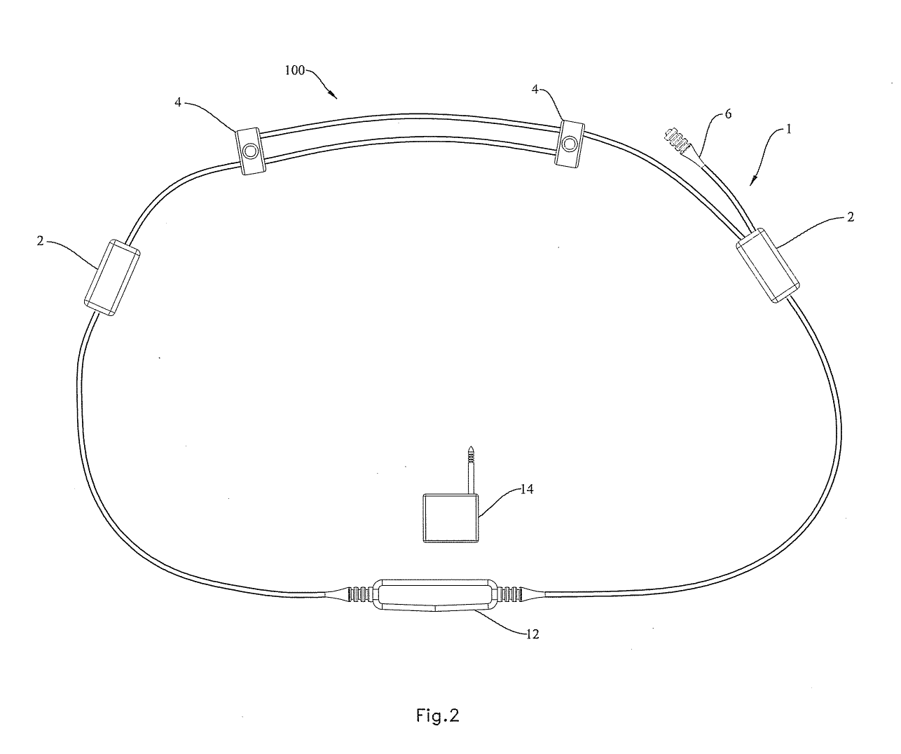

Referring initially to FIGS. 1 and 2, a wireless audio system is shown generally at 100. The audio system 100 includes a wireless lanyard 1 adapted to be worn or otherwise carried by a user of the audio system. The wireless lanyard 1 includes a preferably thin, lightweight cable material having cable connectors 2 and sliding cable locks 4. The cable connectors 2 together with the sliding cable locks 4 enable a user to adjust the size of the wireless lanyard 1, but create enough resistance to lock the wireless lanyard 1 in place once the user adjusts it to a desired position. The wireless lanyard 1 further includes a connector or headphone plug, by way of example; a female electrical receptacle 6 structured and arranged to be releasably electronically connected to a jack 8 of an audio output device, which, for purposes of illustration, may be a pair of headphones 10. It is to be understood that the audio output device may also be in the form of earphones, ear buds, audio earplugs and the like without departing from the scope of the present invention. The wireless lanyard 1 also includes a receiver 12 for wireless communication with an adapter 14 operatively connected to an electronic device or audio source, the operation of which will be described in greater detail below.

The adapter 14 plugs into a connector in an electronic device such as a television, stereo system, radio, compact disc player (CD player), tape player, telephone, MP3 player, iPod or iPhone (not shown), for example, thereby enabling the electronic device to wirelessly communicate with the receiver 12. Preferably, the adapter 14 includes a transmitter that provides wireless communication via a radio frequency (RF) signal and/or short wavelength radio transmissions such as those provided by Bluetooth communication devices. The receiver 12 is configured to receive wireless communication via RF and/or Bluetooth from the adapter. Upon receipt of an audio signal from the transmitter of the adapter 14, the receiver 12 sends the signal to the headphones 10 via the jack 8 plugged into the headphone plug 6. Preferably, an audio wire, which runs substantially coaxially through or is integral with the cable of the wireless lanyard 1, connects the receiver 12 to the headphone plug 6.

Thus, the present invention provides a wireless lanyard system that is structured and arranged to enable wireless operation of an audio output device such as a headphone or headset 10. The headphones 10 can be standard headphones with a standard cable or can be headphones 10 made especially for the wireless lanyard 1. That is, the headphones 10 can include a shortened cable for running to the wireless lanyard 1, which is preferably worn around the neck of the user.

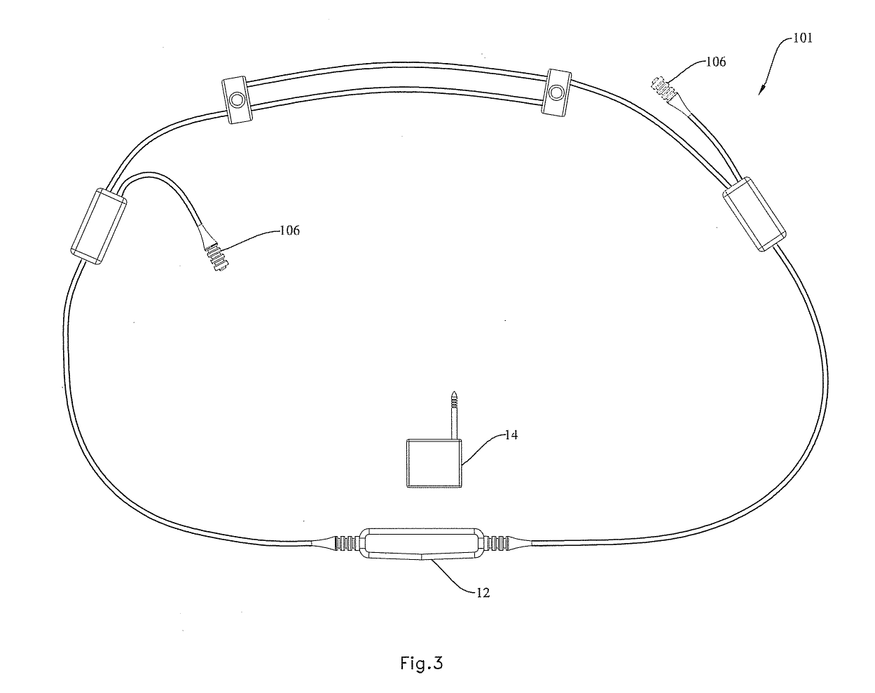

FIG. 3 illustrates another embodiment of a wireless lanyard 101. In this embodiment, the lanyard includes two headphone plugs 106 for the user's convenience.

In understanding the scope of the present invention, the term “comprising” and its derivatives, as used herein, are intended to be open-ended terms that specify the presence of the stated features, elements, components and/or groups, but do not exclude the presence of other unstated features, elements, components and/or groups. The foregoing also applies to words having similar meanings such as the terms, “including”, “having” and their derivatives. The terms of degree such as “substantially”, “about” and “approximate” as used herein mean a reasonable amount of deviation of the modified term such that the end result is not significantly changed. For example, these terms can be construed as including a deviation of at least±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Thus, the foregoing descriptions of the embodiments according to the present invention are provided for illustration only, and not for the purpose of limiting the invention as defined by the appended claims and their equivalents.

What is claimed is:

1. A wireless audio system including an audio source adapted for use by a remote user, comprising:
an audio output device;
a lanyard adapted to be worn by the remote user, the lanyard including means for wirelessly electrically coupling it to the audio source; and
at least one connector for electronically coupling the audio output device to the audio source.

2. The wireless audio system of claim 1 wherein the coupling means comprises an adaptor operatively connected to the audio source and a receiver in wireless communication with the adaptor, the receiver being structured and arranged to receive wireless communication from the adaptor.

3. The wireless audio system of claim 2 wherein the adaptor includes a transmitter for providing wireless communication to the receiver.

4. The wireless audio system of claim 3 wherein the wireless communication is in the form of a radio frequency (RF) signal.

5. The wireless audio system of claim 3 wherein the wireless communication is in the form of a short wavelength radio transmission.

6. The wireless audio system of claim 5 wherein the wireless communication is a Bluetooth signal.

7. The wireless audio system of claim 1 wherein the at least one connector is a female electrical receptacle.

8. The wireless audio system of claim 1 wherein the audio source is selected from a group consisting of a television, a stereo system, a compact disc player, a tape player, a radio, an MP3 player, an iPod and a telephone.

9. The wireless audio system of claim 1 wherein the audio output device is selected from a group consisting of headphones, earphones, ear buds and audio earplugs.

10. The wireless audio system of claim 7 wherein the at least one connector further includes a jack connected to the audio output device, the jack being structured and arranged to be releasably electrically coupled to the female electrical receptacle.

11. The wireless audio system of claim 1 wherein the lanyard includes at least one sliding cable lock structured and arranged to enable the user to adjust the size of the lanyard.

12. The wireless audio system of claim 1 wherein the lanyard comprises a lightweight cable material.

13. The wireless audio system of claim 12 wherein the lightweight cable material includes an audio wire extending substantially coaxially therethrough.

14. The wireless audio system of claim 12 wherein the lightweight cable material includes an audio wire formed integrally therewith.
